(19) United States
(12) Patent Application Publication
(10) Pub. No.: US 2014/0253819 A1
(43) Pub. Date: Sep. 11, 2014

(54) VIRTUAL SALESMAN

(71) Applicant: Richard Graham Walton, Randburg (ZA)

(72) Inventor: Richard Graham Walton, Randburg (ZA)

(73) Assignee: CORE CULTURE MEDIA CC, Johannesburg (ZA)

(21) Appl. No.: 14/128,873

(22) PCT Filed: Jun. 27, 2012
(86) PCT No.: PCT/ZA2012/000045

§ 371 Date: Mar. 6, 2014

(30) Foreign Application Priority Data
Jun. 27, 2011 (ZA) 2011/04734

(51) Int. Cl. G06Q 20/18; H04N 9/31

(52) U.S. Cl. CPC G06Q 20/18; H04N 9/3141
USPC 348/789

(57) ABSTRACT

The Virtual Salesman is the combination of a virtual mannequin, which is a Plexiglass or any transparent material cut-out, that has a special projection foil stuck on the back which turns it into hi-resolution projection screen. A pre-recorded video of an actor/actress or animated character is then projected onto the cut-out, this creates a lifelike video image. There are speakers for sound, either built into the kiosk or in the booth construction. The Virtual Salesman combines this to a touch screen kiosk or touchscreen with an interface having user selectable options, each option having a moving image and or verbal command associated with the option selected on the touchscreen or touchscreen kiosk. The Virtual Salesman reacts to the option selected on the touchscreen or touchscreen kiosk through visual and verbal recordings on the cut-out virtual mannequin.

### FIELD OF THE INVENTION

This invention relates to a booth, and more particularly but not exclusively, to a promotional booth for promoting and/or selling goods and services.

### BACKGROUND TO THE INVENTION

Touch screen kiosks have been in circulation for nearly 10 years and are used in shopping malls, cinemas and airports around the world.

A problem with touch screen kiosks is that they are impersonal and time consuming to use without assistance. This is especially a problem where the target age group for which the kiosk is intended, did not grow up with the technology and find it difficult to understand.

Virtual mannequins are used as virtual assistants and in-window advertising displays in shopping malls, airports and showrooms. Virtual mannequins include a life size glass, Plexiglas™ or other transparent material cut-out, with a layer of projection foil attached thereto. The cut out is used in combination with a projector and speakers whereby a pre-recorded video is projected onto the cut-out to create a life-size moving image. The image and cut-out may take a variety of forms, form cartoon characters to people and creates the impression that the character or person is there in person. A problem with virtual mannequins is that they cannot interact with their audience.

### OBJECT OF THE INVENTION

It is an object of this invention to provide a virtual assistant which, at least partially, alleviates some of the problems associated with the prior art.

### SUMMARY OF THE INVENTION

In accordance with this invention there is provided a booth comprising:
projection means for projecting images and
a cut-out of projection film for displaying the images projected thereon;
an interface having user selectable options, each option having a moving image associated with the option; and
triggering means for triggering projection of a moving image associated with an option selected by a user when the user selects the option.

The booth may include a motion sensor.

The triggering means may trigger the projection of an introductory moving image when the motion sensor detects movement.

The projection means is a projector fixed to a structure of the booth.

The moving images may be digital video projected by the projector.

The booth may include speakers for playing sound associated with the moving image.

The cut-out of projection film is the shape of a person.

The interface may be a touch screen interface and include a computer for storing and providing user selectable options.

The moving images and/or digital video associated with the user selectable options are stored on the computer.

The triggering means may be instructions executed by the computer to send the moving image or digital Video to the projection means.

### BRIEF DESCRIPTION OF THE DRAWINGS

One embodiment of the invention is described below by way of example only and with reference to the drawings in which:

FIG. 1 is a schematic perspective view of a booth according to the invention;

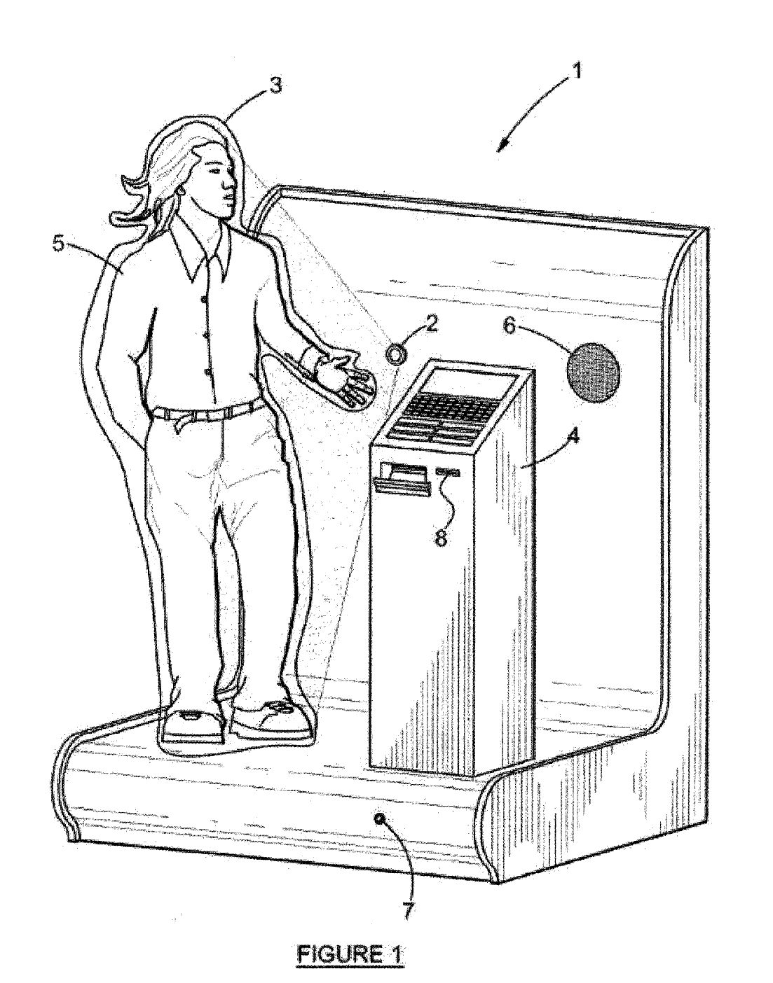

FIG. 2 is a schematic top view of the booth of FIG. 1;

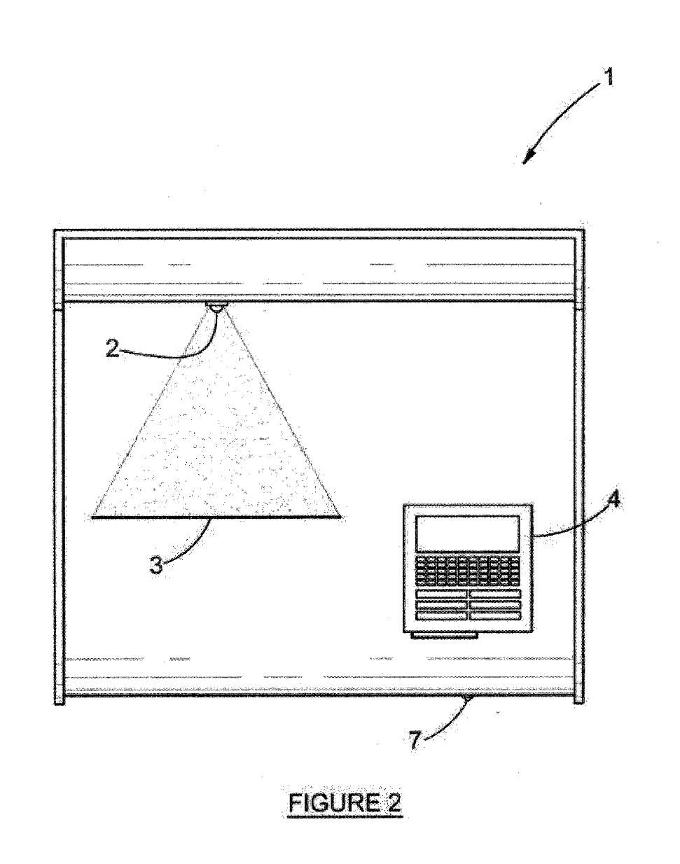

### DETAILED DESCRIPTION OF THE DRAWINGS

With reference to the drawings, in which like features are indicated by like numerals, a booth is generally indicated by reference numeral 1.

The booth 1 includes projection means in the form of a digital projector 2 for projecting images, and a cut-out of projection film 3 for displaying the images projected by the projector 2 thereon. The booth 1 further includes an interface in the form of a touch screen kiosk 4 having user selectable options. Each option has a moving image 5 associated with the particular option. The moving images are stored in the form of digital video on a computer which is connected to the touch screen kiosk. The computer is also connected to the projector 2 and includes triggering means for triggering projection of a moving image associated with an option selected by a user when the user selects the option. The triggering means triggers projection of a particular moving image when a user selects a particular option on the touch screen kiosk.

The cut-out 5 is roughly in the shape of a person and can be any size the booth includes speakers for playing sound associated with the moving images. The moving images 5 are pre recorded by recording digital video of a person standing in the same position as the cut-out 3. If a person speaks or makes small movements such that the movements do not extend beyond the area of the cut out, it will appear and create the impression that a real person is standing next to the kiosk.

In use, the booth 1 will be situated in a shopping mall, airport or other public arena and the motion sensor will detect when a potential user moves past the booth. This will trigger the playback of an introductory moving image 5. The introductory image may be used to draw the attention of the potential user to the booth and encourage him/her to use the kiosk 4 and may even give the user instructions on how to use the kiosk 4 or provide further information about the user selectable options available thereon. The user will then select an option from the user selectable options of the kiosk which will trigger a moving image associated with the particular option to be projected onto the cut-out 5. As an example, when a user selects an option which leads to further available options, the further set of user selectable option will appear on the touch screen of the kiosk 4 and the moving image will guide the user through the further set of options. If the option relates to a particular product or service, the moving image 5 may give the user further information about the product or service. The kiosk 4 may also include a credit card reader 8 which may be utilised by a user to pay for a product, whereby the moving image 5 may provide further information on how to redeem the product once it has been paid for.

It is envisaged that the invention will provide a booth which at least partially alleviates the problems associated with the prior art. It is further envisaged that the booth will provide an interface for users which is familiar, encourage potential users to utilise the kiosk and provide guidance on how to utilise options available on the kiosk.

The invention is not limited to the precise details as described herein. For example, instead of the cut-out being the shape of a person, it may be in the shape of a fictional or cartoon character. Further, a touch screen kiosk need not be used, whereby any manual computer interface may be utilised.

1. A booth comprising:
projection means for projecting images and a cut-out of projection film for displaying the images projected thereon;
an interface having user selectable options, each option having a moving image associated with the option; and
triggering means for triggering projection of a moving image associated with an option selected by a user when the user selects the option.

2. The booth, as claimed in claim 1, including a motion sensor.

3. The booth, as claimed in claim 2, wherein the triggering means triggers the projection of an introductory moving image when the motion sensor detects movement.

4. The booth, as claimed in claim 1, wherein the projection means is a projector fixed to a structure of the booth.

5. The booth, as claimed in claim 1, wherein the moving images may be digital video projected by the projector.

6. The booth, as claimed in claim 1, including speakers for playing sound associated with the moving image.

7. The booth, as claimed in claim 1, wherein the cut-out of projection film is the shape of a person.

8. The booth, as claimed in claim 1, wherein the interface is a touch screen interface and includes a computer for storing and providing user selectable options.

9. The booth, as claimed in claim 8, wherein the moving images and/or digital video associated with the user selectable options are stored on the computer.

10. The booth, as claimed in claim 8, wherein the triggering means comprises instructions executed by the computer to send the moving image or digital video to the projection means.
